(19) United States
(12) Patent Application Publication
(10) Pub. No.: US 2023/0264651 A1
(43) Pub. Date: Aug. 24, 2023

(54) VEHICLE ANTITHEFT APPARATUS

(71) Applicant: TOYOTA JIDOSHA KABUSHIKI KAISHA, Toyota-shi (JP)

(72) Inventors: Hiroshi KIMPARA, Miyoshi-shi (JP); Takao KATAOKA, Nagoya-shi (JP)

(73) Assignee: TOYOTA JIDOSHA KABUSHIKI KAISHA, Toyota-shi (JP)

(21) Appl. No.: 18/087,005

(22) Filed: Dec. 22, 2022

(30) Foreign Application Priority Data
Feb. 21, 2022 (JP) 2022-024683

(51) Int. Cl. B60R 25/09

(52) U.S. Cl. CPC B60R 25/093

(57) ABSTRACT

A vehicle antitheft apparatus that is difficult to cut and fuse is provided. A vehicle antitheft apparatus according to the present disclosure includes an arm part attached to a predetermined place of a vehicle, the arm part being configured to restrict a predetermined movement of the vehicle, and a fixing part configured to fix the arm part. The arm part includes a first layer made of a mixture of alumina and a resin material, and a second layer disposed on an inner side of the first layer, the second layer containing stainless steel. At least a part of an outer surface of the second layer is coated with chromium; the outer surface of the second layer has unevenness; and a linear material containing titanium or iron is provided between the first and second layers.

### CROSS REFERENCE TO RELATED APPLICATIONS

This application is based upon and claims the benefit of priority from Japanese patent application No. 2022-024683, filed on Feb. 21, 2022, the disclosure of which is incorporated herein in its entirety by reference.

### BACKGROUND

The present disclosure relates to a vehicle antitheft apparatus.

Japanese Unexamined Patent Application Publication No. 2015-077928 discloses a vehicle antitheft apparatus that protects a vehicle from a theft by using a tire locking device made of stainless steel.

### SUMMARY

Japanese Unexamined Patent Application Publication No. 2015-077928 discloses a vehicle antitheft apparatus that protects a vehicle from a theft by using a tire locking device made of stainless steel. However, in recent years, criminal techniques for breaking vehicle antitheft apparatuses have become large-scale, such as cutting a vehicle antitheft apparatus with a rotary tool or fusing (e.g., melting and thereby breaking) it with a burner.

Further, as criminal techniques have become large-scale, vehicle antitheft apparatuses are broken more easily and in a shorter time, making it possible to complete the breakage before other persons or the like notice it. These facts have spurred on vehicle thefts.

FIG. 4 shows an example of a conventional vehicle antitheft apparatus. The conventional vehicle antitheft apparatus 100 includes an arm part 102 for restricting the movement of a tire 101, and a fixing part 103 for fixing the arm part 102. It cannot be said that the arm part 102, which is made of stainless steel, is sufficiently resistant to cutting by a rotary tool or fusing (i.e., melting and breaking) by a burner.

The present disclosure has been made in order to solve the above-described problem, and an object thereof is to provide a vehicle antitheft apparatus that is difficult to cut or fuse (i e, melt and break).

A vehicle antitheft apparatus according to the present disclosure includes: an arm part attached to a predetermined place of a vehicle, the arm part being configured to restrict a predetermined movement of the vehicle; and a fixing part configured to fix the arm part. The arm part includes: a first layer made of a mixture of alumina and a resin material; a second layer disposed on an inner side of the first layer, the second layer containing stainless steel. At least a part of an outer surface of the second layer is coated with chromium; the outer surface of the second layer has unevenness; and a linear material containing titanium or iron is provided between the first and second layers.

As described above, the vehicle antitheft apparatus including, in the arm part, the first layer, which has high heat resistance and high thermal insulation, and thereby makes fusing of it difficult, and the second layer, which includes a hard coating part and a soft linear material, and thereby makes cutting of it difficult, can increase its resistance to cutting and fusing.

The unevenness formed on the outer surface of the second layer may have a twisted shape in a direction in which the arm part extends. By the above-described configuration, the durability against cutting can be increased.

The resin material may be at least one substance selected from the group consisting of fiber-reinforced plastic, polyethylene terephthalate, polyamide, polyetherimide, and polyphenylene sulfide. By selecting such a material, the durability against fusing can be increased.

The linear material may be disposed in a recessed part of the unevenness of the second layer. By the above-described configuration, the durability against cutting can be increased.

At least a part of an outer surface of the first layer may be coated with chromium. By the above-described configuration, the strength of the first layer can be increased.

The vehicle antitheft apparatus may include a central part containing titanium on an inner side of the second layer. By the above-described configuration, the rigidity of the vehicle antitheft apparatus can be increased.

According to the present disclosure, it is possible to provide a vehicle antitheft apparatus that is difficult to cut and fuse (i.e., melt and break).

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a simplified diagram of a vehicle antitheft apparatus according to a first embodiment as viewed from the front;

FIG. 2 is a cross-sectional diagram taken along a dashed line II-II in FIG. 1;

FIG. 3 is a cross-sectional diagram taken along a dashed line III-III in FIG. 2; and

FIG. 4 shows an example of a conventional vehicle antitheft apparatus.

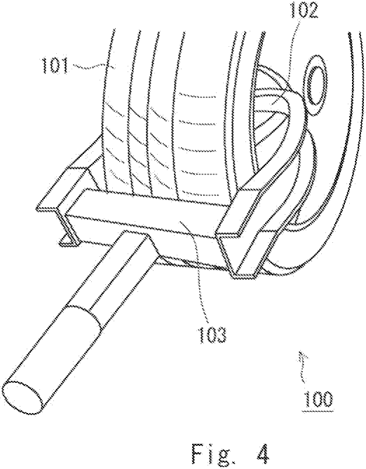

### DESCRIPTION OF EMBODIMENTS

### First Embodiment

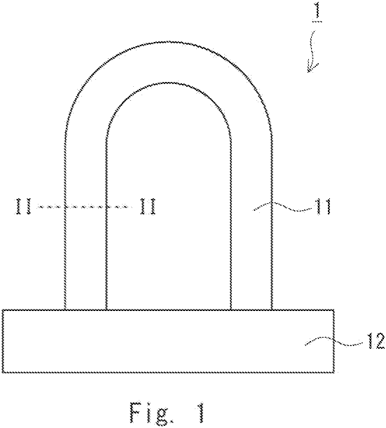

Embodiments according to the present disclosure will be described hereinafter with reference to the drawings. FIG. 1 shows a schematic diagram of a vehicle antitheft apparatus according to this embodiment as viewed from the front. The vehicle antitheft apparatus 1 includes an arm part 11 and a fixing part 12. The arm part 11 is attached to a predetermined place of a vehicle and restricts a predetermined movement of the vehicle. The fixing part 12 fixes the arm part 11. The vehicle antitheft apparatus 1 shown in FIG. 1 shows, as an example, an example of a configuration of a tire locking device, which protects the vehicle from a theft by attaching the arm part 11 to a tire of the vehicle and thereby restricting the rotational movement of the tire.

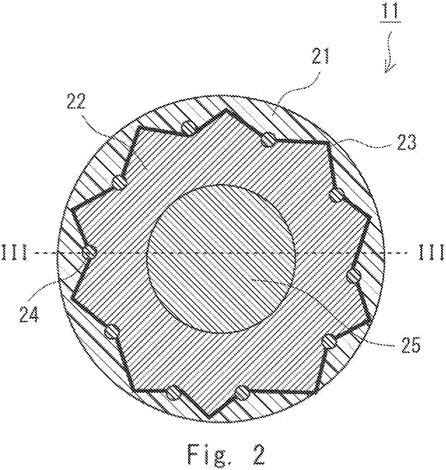

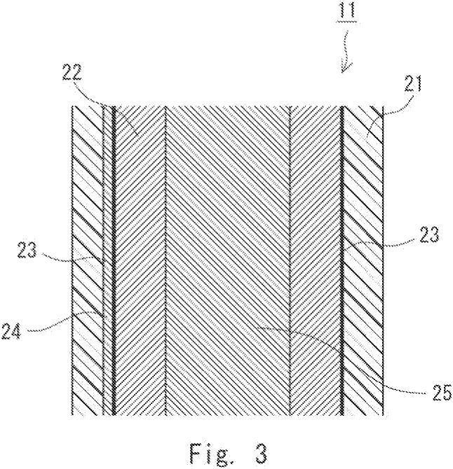

FIG. 2 shows a cross section of the arm part 11 taken along a dashed line II-II in FIG. 1, and FIG. 3 shows a cross section of the arm part 11 taken along a dashed line III-III in FIG. 2. The arm part 11 includes a first layer 21, a second layer 22, a coating part 23, a linear material 24, and a central part 25. As shown in FIGS. 2 and 3, the first layer 21 is disposed on the outer side of the second layer 22, and the second layer 22 is disposed on the outer side of the central part 25.

The first layer 21 shown in FIGS. 2 and 3 is a layer made of a mixture containing an alumina powder and a resin material as main materials. In the case of high-purity alumina containing 99.9% of Al₂O₃ or more as a raw material, the alumina powder has a high melting point of about 2,072° C. and hence has excellent heat resistance.

The resin material is preferably a fiber-reinforced plastic (FRP). The fiber-reinforced plastic is a plastic whose strength is improved by mixing fibers in the resin. Examples of the above-described resin include epoxy resins, polyester resins, and polyamide resins. Examples of the above-described fibers include carbon fibers, glass fibers, and aramid fibers. For example, a glass fiber-reinforced plastic has low thermal conductivity of about 0.2 W/mK and hence has an excellent thermal insulation property.

The material in which an alumina powder and a resin material are mixed has a high heat resistance property and a high thermal-insulation property, so it is highly durable against thermal fusing using a burner or the like. By using the first layer 21 containing such materials for the arm part 11, it is possible to provide a vehicle antitheft apparatus which it takes a long time to fuse.

The second layer 22 shown in FIGS. 2 and 3 is a layer containing stainless steel as the main material. As shown in FIG. 2, which shows the cross section taken along the dashed line II-II in FIG. 1, the surface of the second layer 22, i.e., the outer circumferential surface of the second layer 22, has an uneven shape. The uneven shape may be a polygonal shape or a shape having projecting parts like a gear wheel.

The chromium-plated coating part 23 is provided so as to cover at least a part of the surface of the second layer 22. The chromium plating has Vickers hardness of 800 to 1,000 HV, which is extremely high among various types of metal plating of which surface coating process by electroplating is possible. For example, Vickers hardness of nickel plating, tin-cobalt alloy plating, and zinc-nickel alloy plating are 100 to 350 HV, 400 to 500 HV, and 200 to 300 HV, respectively.

The linear material 24 contains titanium or iron as the main material. Vickers hardness of titanium and iron are both about 110 HV, so they are softer materials as compared to the chromium-plated coating part 23. Further, as shown in FIG. 2, the linear material 24 is disposed in recessed parts of the second layer 22 having the uneven shape. That is, the surface of the second layer 22 includes the coating part 23 made of a hard material, and the linear material 24 made of a soft material, and has the uneven shape.

The central part 25 is disposed on the inner side of the second layer 22 and has a function for increasing the rigidity of the arm part 11. The supposed main material of the central part 25 is titanium, but materials other than titanium may be used as long as the rigidity of the arm part 11 can be maintained. For example, steel materials such as hot-rolled steel, cold-rolled steel, and carbon steel may be used. Note that the central part 25 is not indispensable, and in such a case (i.e., a case where the central part 25 is not provided), the substitute for the central part 25 may be formed by the second layer 22.

When the arm part 11 is cut by using a rotary tool, the blade of the rotary tool first comes into contact with the first layer 21, which is located in the outermost layer of the arm part 11. Because the first layer 21 contains the resin material, the heat generated by the contact with the blade of the rotary tool causes the resin material to stick to and adhere to the blade, thus impairing the function of the rotary tool. Then, when the coating part 23 and the linear material 24 of the second layer 22 come into contact with the blade of the rotary tool, firstly, the linear material 24, which is soft, adheres to the blade, thus making it possible to further impair the function of the rotary tool.

In addition, the stainless steel contained in the second layer 22 is a high thermal-insulation material among various types of metal materials, so that the heat generated by the contact with the blade of the rotary tool is less likely to be transferred therethrough. At this point, the generated heat is concentrated on the blade of the rotary tool and accelerate the wear of the rotary tool, thus making the cutting of the arm part 11 more difficult.

Further, when the arm part 11 is fused (i.e., melted and broken) by using a burner, the alumina powder having a high heat resistance property makes the fusing difficult. Further, since the resin material contained in the first layer 21 has a high thermal-insulation property, it exhibits a function of preventing the heat from being transferred to the second layer 22 and the central part 25. As described above, since the stainless steel contained in the second layer 22 has also a high thermal-insulation property, it can make the fusing of the arm part 11 more difficult.

As described above, it is possible to provide the vehicle antitheft apparatus 1 of which the fusing and the cutting of the arm part 11 is difficult, and which it takes a long time to break.

Note that the present disclosure is not limited to the above-described embodiment, and it can be modified as appropriate without departing from the scope and spirit thereof. For example, the embodiment may be modified as described hereinafter.

The surface of the first layer 21 may also be chromium-plated in order to reinforce the first layer 21, and the first layer 21 may also have an uneven shape or a polygonal shape in cross section. In this way, the durability of the first layer 21 against cutting and fusing can be further improved.

In addition to the fiber-reinforced plastic, engineering plastics having low thermal conductivity such as polyethylene terephthalate (PET), polyamide (PA), polyetherimide (PEI), and polyphenylene sulfide (PPS) may be used as the resin material contained in the first layer 21. By using these materials, the manufacturing cost of the vehicle antitheft apparatus can be reduced.

The unevenness formed on the outer surface of the second layer 22 may have a twisted shape in the direction in which the arm part extends, and the linear material 24 may be partially provided along the twisted shape. For example, this twisted shape may change in a continuous manner like a drill blade, or it may have different uneven shapes.

The chromium-plating process for forming the coating part 23 is performed after the formation of the second layer 22. However, it may be performed after the formation of the linear material 24, so that the coating part 23 is provided so as to cover the second layer 22 and the linear material 24.

Further, the vehicle antitheft apparatus 1 according to the present disclosure may be configured so as to lock a steering wheel rather than to lock a tire. In this case, for example, it protects a vehicle from a theft by attaching a rod-like arm part to the steering wheel of the vehicle and thereby restricting the rotational movement of the steering wheel.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A vehicle antitheft apparatus comprising:
an arm part attached to a predetermined place of a vehicle, the arm part being configured to restrict a predetermined movement of the vehicle; and
a fixing part configured to fix the arm part, wherein
the arm part comprises:
a first layer made of a mixture of alumina and a resin material; and
a second layer disposed on an inner side of the first layer, the second layer containing stainless steel,
at least a part of an outer surface of the second layer is coated with chromium,
the outer surface of the second layer has unevenness, and
a linear material containing titanium or iron is provided between the first and second layers.

2. The vehicle antitheft apparatus according to claim 1, wherein the unevenness formed on the outer surface of the second layer has a twisted shape in a direction in which the arm part extends.

3. The vehicle antitheft apparatus according to claim 1, wherein the resin material is at least one substance selected from the group consisting of fiber-reinforced plastic, polyethylene terephthalate, polyamide, polyetherimide, and polyphenylene sulfide.

4. The vehicle antitheft apparatus according to claim 1, wherein the linear material is disposed in a recessed part of the unevenness of the second layer.

5. The vehicle antitheft apparatus according to claim 1, wherein at least a part of an outer surface of the first layer is coated with chromium.

6. The vehicle antitheft apparatus according to claim 1, further comprising a central part containing titanium on an inner side of the second layer.
